(19) United States
(12) Patent Application Publication
(10) Pub. No.: US 2007/0056433 A1
(43) Pub. Date: Mar. 15, 2007

(54) Method and Apparatus For Flexibly Processing, Storing, and Retrieving Audio Data

(76) Inventor: Eric Christopher Huffman, Chicago, IL (US)

Correspondence Address: WHITE-WELKER & WELKER, LLC, P.O. BOX 199, CLEAR SPRING, MD, 21722-0199, US

(21) Appl. No.: 11/466,768

(22) Filed: Aug. 23, 2006

Related U.S. Application Data
(60) Provisional application No. 60/712,257, filed on Aug. 29, 2005.

(51) Int. Cl. G10H 7/00

(52) U.S. Cl. 84/645

(57) ABSTRACT

A method and apparatus for flexibly processing, storing, and retrieving audio data. The present invention enables producers of music to take audio data that has been generated within a commercially available Digital Audio Workstation (DAW) and then, by applying the method and apparatus of the present invention, to create an Adaptable Music File. This Adaptable Music File may then be transmitted over communications channels, stored in devices, and used by the present invention to generate music for users of music in a manner that solves the problems noted above.

### CROSS REFERENCE TO RELATED APPLICATIONS

This application claims priority from U.S. Provisional Patent Application Ser. No. 60/712,257, entitled “Method and Apparatus for Automating the Mixing of Multi-Track Digital Audio”, filed on Aug. 29, 2005.

### FEDERALLY SPONSORED RESEARCH

Not Applicable

### TECHNICAL FIELD OF THE INVENTION

The present invention relates generally to audio data. More specifically the present invention relates to a method and apparatus for flexibly processing, storing, and retrieving audio data.

Program Appendixes:

Appendix A lists pseudocode comprising program steps necessary to explain the performance of each of the processes that make up the program of the preferred embodiment used by the system of the present invention;
Appendix B lists pseudocode comprising program headers and steps necessary to explain the performance of each of the processes that make up the program of the preferred embodiment used by the system of the present invention;
Appendix C lists partial pseudocode comprising program headers and steps necessary to explain the performance of the event map processes that makes up the program of the preferred embodiment used by the system of the present invention; and
Appendix D lists partial pseudocode comprising program headers and steps necessary to explain the performance the hierarchical event map processes that makes up the program of the preferred embodiment used by the system of the present invention.

### BACKGROUND OF THE INVENTION

Music is used in a variety of products and works. For example, music is often used in web applications, computer games, and other interactive multimedia products. Music is also often used in other works such as television advertising, radio advertising, commercial films, corporate videos, and other media.

Working with music during the production of products and works that use music can be complicated and time consuming. In a first example, if the music in use is from a music library, it is fixed in linear time and therefore requires that the user of the music engage in the time consuming task of editing the music to alter it to fit the requirements of the product or work being produced. In a second example, when music is produced by a composer, it is often the case that the producers of the product or work and the composer will engage in several time consuming iterations of producing the music and altering the music before the music fits the requirements of the product or work being produced. Therefore it is an objective of the present invention to provide method and apparatus for reducing the complexity and time needed to produce a musical work.

When music is delivered to the user of music, it is often the case that the music is compressed using a lossy algorithm that reduces the quality of the music unacceptably. Additionally it is also equally as common that when the music is delivered to the user of music, it is delivered in a multi-channel linear format that is unacceptably large to transmit over networks and other communication channels and unacceptably large to store within various devices. Therefore it is an objective of the present invention to provide method and apparatus the compresses music using an improved algorithm that does not reduce the quality of the music to an unacceptable level while at the same time providing delivery of the music in a format that is easily transmitted over networks and communications channels and requires reduced storage space.

Others have attempted to solve the same and similar issues presented above, but have failed in accomplishing these objectives. For example, U.S. Pat. No. 6,930,236 teaches an Apparatus for Analyzing Music Using Sounds of Instruments; U.S. Pat. No. 6,924,425 teaches a Method and Apparatus for Storing a Multipart Audio Performance with Interactive Playback; U.S. Pat. No. 5,970,461 teaches a System, Method and Computer Readable Medium of Efficiently Decoding an AC-3 Bitstream by Precalculating Computationally Expensive Values to be Used in the Decoding Algorithm; U.S. Pat. No. 5,083,310 teaches a Compression and Expansion Technique for Digital Audio Data; and U.S. Pat. No. 6,829,648 teaches a Method and Apparatus for Preparing Media Data for Transmission.

### SUMMARY OF THE INVENTION

In accordance with the present invention a method and apparatus for flexibly processing, storing, and retrieving audio data is provided which overcomes the aforementioned problems of the prior art.

The present invention is a method and apparatus for flexibly processing, storing, and retrieving audio data. The present invention enables producers of music to take audio data that has been generated within a commercially available Digital Audio Workstation (DAW) and then, by applying the method and apparatus of the present invention, to create an Adaptable Music File. This Adaptable Music File may then be transmitted over communications channels, stored in devices, and used by the present invention to generate music for users of music in a manner that solves the problems noted above.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart that illustrates the event map data structure;

FIG. 2 is a flow chart illustrating the first process canvas;

FIG. 3 is a flow chart illustrating the second process canvas; and

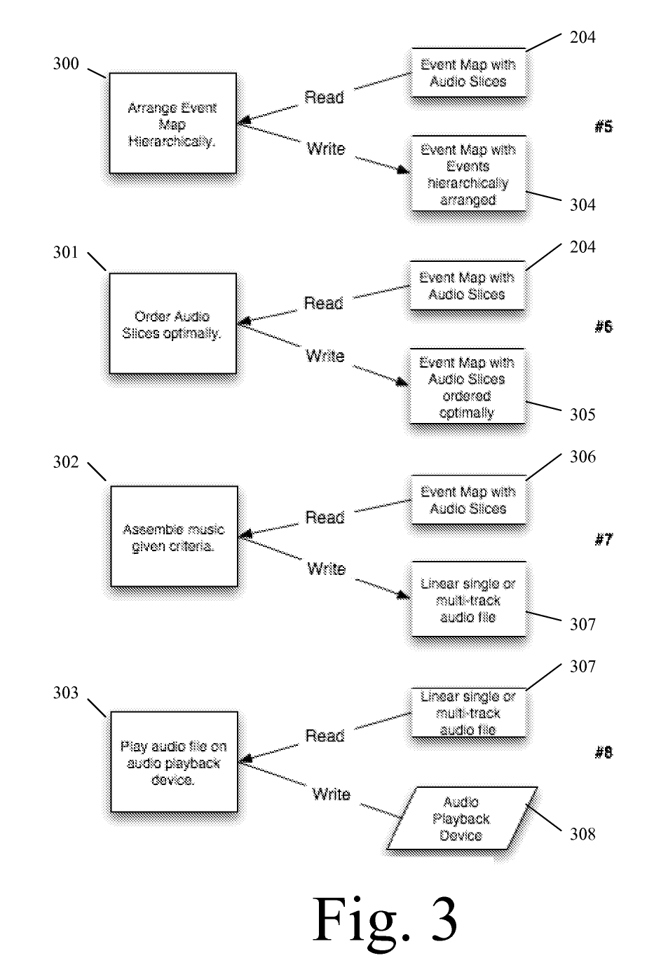

FIG. 4 is a diagram of the present invention's various physical components

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a method and apparatus for flexibly processing, storing, and retrieving audio data.

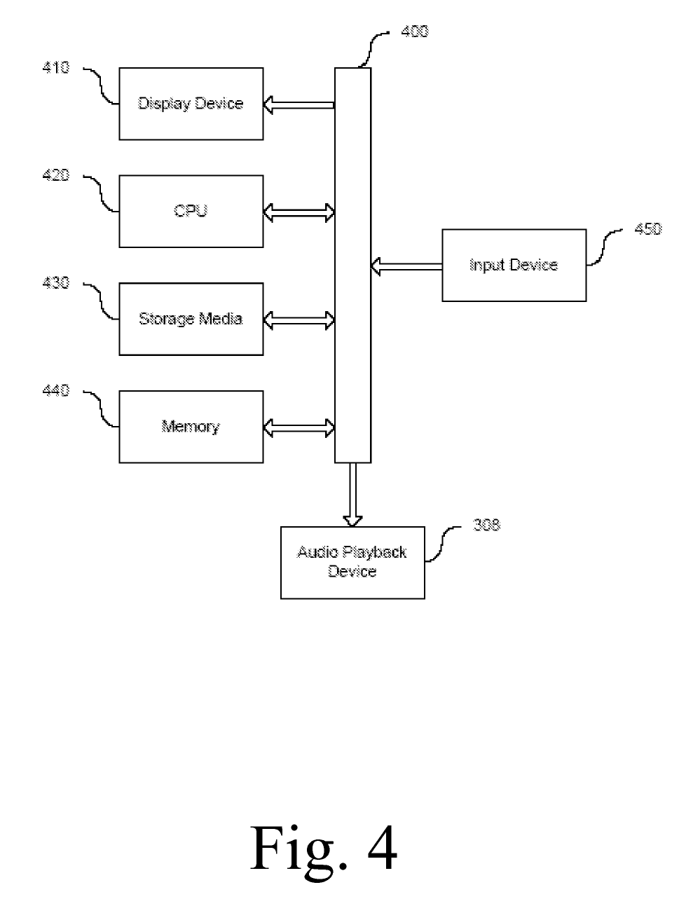

Now referring to FIG. 4, the physical embodiment of the present invention is a computer-based system of interacting components. The major physical elements are: a buss 400 that allows various components of the system to be connected or wired; an input device 450 such as a keyboard or mouse provides user input utilized by the system; a display device 410 such as a video card and computer screen provides the user with visual information about the system via a user interface; a CPU 420 of sufficient processing power handles the system's processing; storage media 430 stores the program steps for the system's processing; and a memory 440 of sufficient size stores any data resulting from, or for, the system's processing.

Still referring to FIG. 5, the buss 400, CPU 420, storage media 430, memory 440, input device 450, and display device 410 will preferably be components of a computer. The audio playback device 308 may be a component of the computer but may also be a device external to the computer such as a digital to analog audio converter. The audio playback device 308 is preferably connected to other devices, such as an audio amplifier and speakers. The buss 400, CPU 420, storage media 430, memory 440, input device 450, display device 410, and audio playback device 308 are well-known components to those with ordinary skill in the electronic and mechanical arts. The method or arrangement of wiring or connecting these components in a manner that is suitable for the operation of the system is also well known to those with ordinary skill in the electronic and mechanical arts, but their novel and non-obvious combination in the present invention with the Method For Flexibly Processing, Storing, and Retrieving Audio Data of the present invention improves upon the prior art.

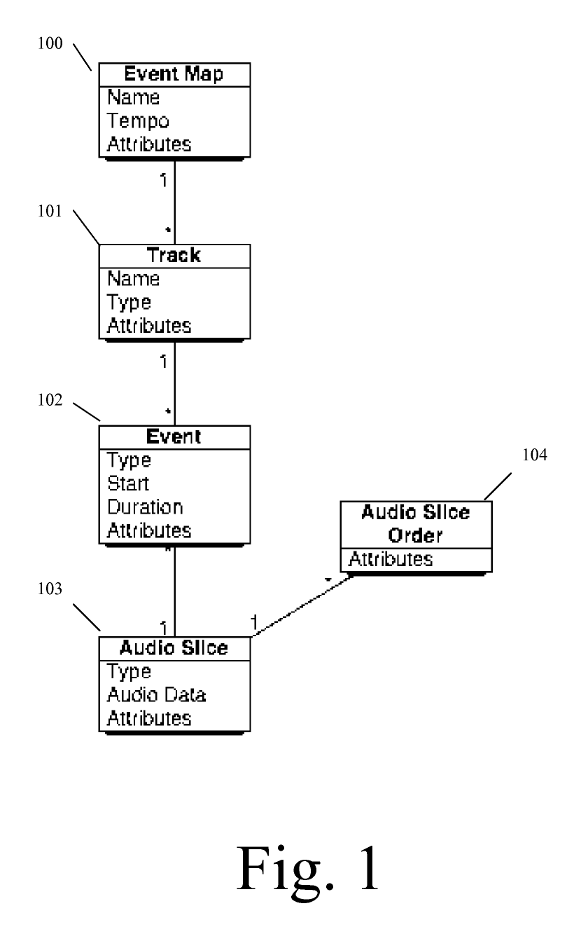

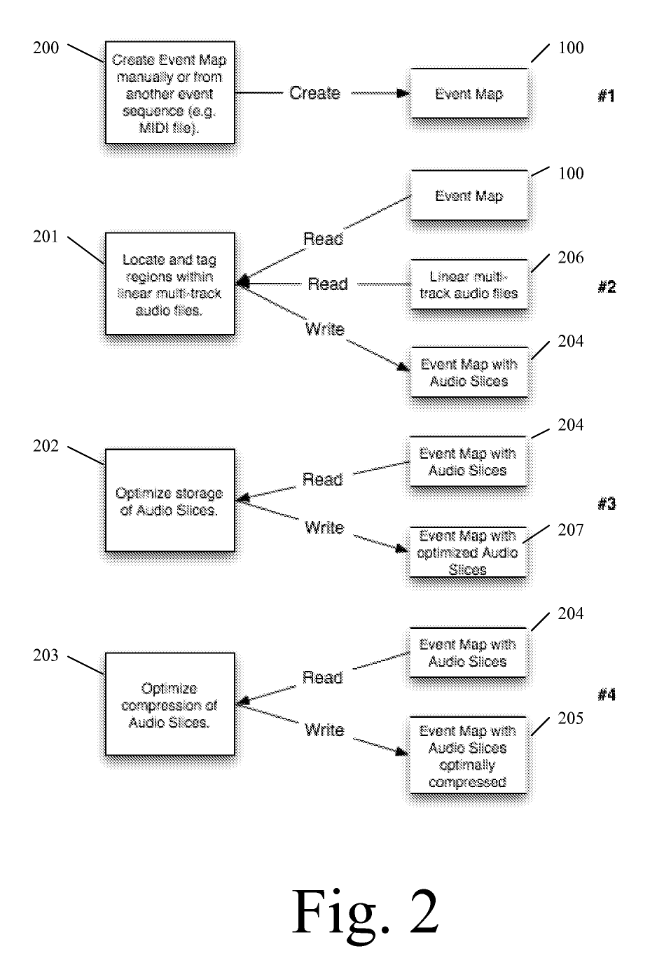

Now referring to FIG. 1, specifically, the method and enabling software sytem of the present invention uses an Event Map 100 as illustrated in FIG. 1 and further detailed in FIGS. 2 & 3. In step #1, the Event Map 100 may be constructed manually or be generated from a Standard MIDI File (SMF) 200. In step #2, the Event Map 100 is used to automatically locate regions of audio data with linear multi-track 206 audio files that may be exported from commercial DAWs 201. Audio Slices 103 may contain the located region information as well as the audio data within a located region in one of any number of compressed or uncompressed audio formats.

Events within the Event Map 100 may then reference the Audio Slice 103 associated with the located region 204. When these regions of audio data are located, they may be tagged with meta-data present in the Event Map 100. This meta-data may include attributes such as pitch, velocity, and other musical attributes. This meta-data may then be stored in the associated Audio Slices 103.

In step #3, the Storage of Audio Slices 202 may be optimized by storing Audio Slices 103 with similar audio data only once and directing the referencing Events 102 to reference the single remaining Audio Slice 207. In step #4, the storage of audio data 204 contained within an Audio Slice 103 may be optimized by searching for and finding the audio compression setting or format 203 that results in the smallest compressed audio size that is within a specified quality criteria 205.

The arrangement of Events 102 with respect to each other may be stored in a hierarchical arrangement 300 during Step #5 that facilitates the flexible assemble of audio data contained within Audio Slices 304.

In step #6, the order in which Audio Slices 103 and the contained audio data are stored 301 in an Adaptable Music File may be optimized for retrieval 305. For instance, if it is anticipated that Audio Slices 103 will be assembled in time order, irrespective of the originating linear multi-track origin, the audio data associated with the Audio Slices 305 may be sorted and stored in start time order.

In step #7, the Adaptable Music File may be used by the present invention to assemble music 302 for use by users of music in a number of flexible manners. For instance, the original linear multi-track 306 audio data may be assembled; individual tracks may be selected for assembly; nodes within the hierarchical arrangement may be selected and re-ordered prior to assemble; or an algorithm may utilize the hierarchical arrangement and/or meta-data to assemble the audio data 307.

In step #8, once the music has been assembled, it may be stored and/or played 303 over a sound producing system 308.

Therefore, it should be understood that the method and apparatus of the invention can be practiced with modification and alteration within the spirit and scope of the appended claims. The description is thus to be regarded as illustrative instead of limiting on the invention.

Example Pseudo-Code Implementations

The following pseudo-code segments are provided to aid in understanding the various parts of the present invention. They should not be construed as complete or optimal implementations. Note that these codes illustrate the operation of the basic system described above, without any of the additional enhancements discussed. Although given as software code, the actual implementations may be as stored-program(s) used by a processor, as dedicated hardware, or as a combination of the two.

1. A method for flexibly processing, storing, and retrieving audio data comprising:
an Event Map;
said Event Map automatically locates regions of audio data within linear multi-track audio files;
Audio Slices contain the located region information as well as the audio data;
Events within the Event Map reference an Audio Slice associated with the located region;
when said regions of audio data are located, they are tagged with meta-data present in the Event Map;
said meta-data may then be stored in the associated Audio Slices; and
the arrangement of Events with respect to each other are stored in a hierarchical arrangement that facilitates the flexible assemble of audio data contained within Audio Slices.

2. The method for flexibly processing, storing, and retrieving audio data of claim 1 wherein the storage of Audio Slices is optimized by storing Audio Slices with similar audio data only once and directing the referencing Events to reference the single remaining Audio Slice;

3. The method for flexibly processing, storing, and retrieving audio data of claim 2 wherein the order in which Audio Slices and the contained audio data are stored in an Adaptable Music File is first optimized for retrieval.

4. The method for flexibly processing, storing, and retrieving audio data of claim 3 wherein the event map is constructed manually or generated from a Standard MIDI File.

5. The method for flexibly processing, storing, and retrieving audio data of claim 3 wherein the automatically located regions of audio data with linear multi-track audio files are exported from a commercial Digital Audio Workstation.

6. The method for flexibly processing, storing, and retrieving audio data of claim 3 wherein the Audio Slices contain the located region information and audio data within a located region in one of any number of compressed audio formats.

7. The method for flexibly processing, storing, and retrieving audio data of claim 3 wherein the meta-data includes attributes such as pitch and velocity.

8. The method for flexibly processing, storing, and retrieving audio data of claim 3 wherein the storage of audio data contained within an Audio Slice is optimized by searching for and finding the audio compression setting or format that results in the smallest compressed audio size that is within a specified quality criteria.

9. The method for flexibly processing, storing, and retrieving audio data of claim 3 wherein the Audio Slices are assembled in time order, the audio data associated with the Audio Slices is sorted and stored in start time order.

10. The method for flexibly processing, storing, and retrieving audio data of claim 3 wherein the Adaptable Music File assembles music for use by users of music in a plurality number of flexible manners.

11. The method for flexibly processing, storing, and retrieving audio data of claim 3 wherein when an original linear multi-track audio data is assembled;
individual tracks are selected for assembly; and
nodes within the hierarchical arrangement are selected and re-ordered prior to assemble.

12. The method for flexibly processing, storing, and retrieving audio data of claim 11 wherein an algorithm utilizes the hierarchical arrangement to assemble the audio data.

13. The method for flexibly processing, storing, and retrieving audio data of claim 12 wherein once the music has been assembled it is stored in a sound producing system.

14. The method for flexibly processing, storing, and retrieving audio data of claim 12 wherein once the music has been assembled it is played over a sound producing system.

15. An apparatus for flexibly processing, storing, and retrieving audio data consisting of: software means for generating music for users from Adaptable Music Files.

16. The apparatus for flexibly processing, storing, and retrieving audio data of claim 15 wherein the apparatus consists of:
software means creating one or more Adaptable Music Files;
means for transmitting said Adaptable Music Files over communications channels; and
means for saving said Adaptable Music Files to a storage device.

17. The apparatus for flexibly processing, storing, and retrieving audio data of claim 16 wherein the apparatus is comprised of
a computer-based system of interacting components consisting of:
a buss,
an input device,
a display device,
a CPU,
storage media for storing the program steps for the system's processing;
a memory for storing any data resulting from or the system's processing; and
an audio device.

18. The apparatus for flexibly processing, storing, and retrieving audio data of claim 17 wherein the audio device is either
a component of the computer; or
a device external to the computer.

19. The apparatus for flexibly processing, storing, and retrieving audio data of claim 18 wherein the device external to the computer is a digital to analog audio converter.

20. The apparatus for flexibly processing, storing, and retrieving audio data of claim 18 wherein the audio device is connected to one or more additional audio devices.
